(19) United States
(12) Patent Application Publication
(10) Pub. No.: US 2012/0094816 A1
(43) Pub. Date: Apr. 19, 2012

(54) METHOD FOR MANUFACTURING A CONTAINER OF PAPER MATERIAL FOR FOOD, FOR EXAMPLE LIQUIDS, IN PARTIUCLAR DRINKS SUCH AS A PAPER GLASS FOR HOT DRINKS

(75) Inventors: Giorgio Trani, Venezia (IT); Gianmario Anghileri, Malgrate (Lecco) (IT); Marion Sterner, Venezia (IT)

(73) Assignee: NOVACART S.P.A., GARBAGNATE MONASTERO (LECCO) (IT)

(21) Appl. No.: 13/143,889

(22) PCT Filed: Jan. 8, 2010
(86) PCT No.: PCT/IB2010/000019

§ 371 Date: Jul. 28, 2011

(30) Foreign Application Priority Data
Jan. 8, 2009 (IT) MI2009A00/0005

(51) Int. Cl. B31B 1/00

(52) U.S. Cl. 493/52

(57) ABSTRACT

A method has been conceived for the manufacture of containers in paper material for foodstuffs such as drinks, in particular hot drinks, comprising a bottom wall (2) and a lateral wall (3) arising from the bottom wall (2) and forming in cooperation with the latter a cavity (4) for containing the product; means (5) are also provided to allow the hand of a user to be thermally insulated with respect to the product contained in the cavity (4). The method comprises a step of turning the lateral wall (3) back outwards and downwards so that the material constituting the upper portion of the lateral wall of the preliminary container comes step by step to constitute the external strip (6).

The present invention has as its subject a production method for the manufacture of containers particularly, but not exclusively, for foodstuffs, for example liquids, more specifically drinks, and in particular beakers destined for containing hot drinks in which the container itself is provided with suitable means for avoiding the excessive transfer of heat to the hands of the consumer. As is well-known, there are on the market various types of paper beakers, made to allow the consumption of hot or very hot drinks, thanks to the presence of suitable means which allow the container itself to be handled without the user being burned. A first known type of such beakers specifies the use of an additional insulating body which is fixed to the outside of the beaker, generally counter-profiled to the lateral wall of the beaker itself and made of thermally non-conductive material such as polystyrol or similar. Although performing the proposed task outstandingly well, such a structure requires the use of different materials and does not allow the beakers to be stackable because of the thickening of the dimensions of the lateral wall. Another known type of such containers specifies that the lateral wall should consist of at least one layer of paper material to which is coupled corrugated cardboard consisting of two sheets coupled together. The corrugations distance the user's hand from the hot drink and the air functions as thermal insulation. Such containers, however, as mentioned above, entail the use of at least three overlapping layers of cardboard with consequent increases in costs and production times. A further type of known container consists, as regards its lateral wall, of a double layer of paper material in which, before being coupled together, the second, outermost layer is suitably pierced so as to create one or two supporting handles which emerge radially from the lateral wall and which allow the beaker to be handled without touching its hot lateral wall. It is obvious that this structure, although it does allow the products to be stackable (only partially, in any case, because of the doubling of the thickness of the lateral wall), requires greater consumption of raw materials at the production stage, as well as a series of further working steps to create this second wall, pierce it and fix it to the structure of the beaker so as to form the aforesaid handles. Obviously, the above entails increased costs, which are sometimes unacceptable in the context of products consumed in large quantities but of low unit value. A further type is known of paper beakers in which at least the outer layer of the two which constitute the lateral wall is made of elastically deformable paper so that, before attachment, the layer can be suitably shaped so as to present raised panels which once again distance the consumer's hand from the hot drink; in this case the beaker is produced using only two layers of paper.

Also known from document EP 1474333 is a method of manufacturing a beaker in paper material which requires starting from a flat sector of a circle of suitable food-grade cardboard and forming a folding line in the shape of an arc of circumference. The procedure requires turning back outwards an upper band of the flat sector of a circle and then rolling the folded sector back on itself in such a way as to form simultaneously both the lateral wall and a turned-back border strip of the beaker itself. The next step is to weld the opposed edges of the circular sector along the vertical wall and to join a bottom wall to the beaker thus created.

The method described in accordance with the European patent cited, while specifying few essential steps, reveals itself however to be complex, in particular with reference to the stages of welding the opposed edges of the circular sector and with reference to the coupling of the bottom wall. The process in fact requires working with surfaces which are hard to control in an industrial and repeatable fashion, making the process described possible in fact only in the creation of prototypes, but not transferable to industrial production machines.

It should be noted that welding the extreme edges of a strip that has already been turned back appears not only critical but also essential, given that a faulty or even only partial weld entails the unusability of the container, which would no longer be liquid-tight.

Furthermore, an edge strip formed as described tends to close up on itself particularly during the stage of turning up the circular sector. This characteristic tends to impair the insulating properties of the beaker and also seriously limits its stackability, which as a result is only partial.

Document EP 291326 on the other hand describes a method for rendering a plastic beaker thermally insulated. In particular it provides for the creation of a separate edge strip in paper material, shaped to follow a course which is circular in section. The substantially cylindrical strip is attached to an upper edge of the plastic beaker and is provided with suitable discharge notches to allow the lateral strip to collapse on itself for purposes of stackability. It must however be noted that these channels weaken the edge strip and make it easily collapsible and therefore this embodiment solution is exclusively applicable to beakers provided with annular portions emerging like those described in the European patent mentioned, which keep the annular portion at least at a minimal distance, thus ensuring that it functions as an insulant. It must however be noted that the application of this type of border to a beaker of paper material which could not however have this protruding element is in fact impossible because the beaker would substantially lose its characteristic of thermal insulation.

In an alternative embodiment solution the procedure specifies forming a perimetral strip with a tapered shape which is coupled to the plastic beaker at its largest diameter in the area of the upper opening of the beaker. The lower portion of the lateral strip also abuts against an annular element projecting from the plastic beaker to guarantee the presence of the above-mentioned insulating interspace. In this second embodiment, too, the presence of the constricting strip in the plastic beaker proves to be essential, and therefore the same embodiment is not applicable to beakers of paper material.

In this situation the object of the present invention is to make available a new method for the manufacture of beakers for drinks which is capable of substantially resolving the disadvantages mentioned. A first object of the invention is to make available a method that is industrializable, simple and inexpensive for the manufacture of drink containers provided with means for the use of the beaker without burning the hands during the consumption of hot drinks, made with a single-layer wall with a considerable saving of materials and processing time. It is also a principal object to propose a production method which makes it possible to obtain a product which is also easily stackable and costs a moderate amount. A further ancillary object of the invention is to make available a number of specific exemplary and alternative production methods which enable the manufacture of said container in an industrializable manner with few processing steps, particularly by operating on a paper beaker structure (by deformation or gluing) of a substantially standard type.

These and other objects which will appear more clearly in the course of the subsequent description are substantially achieved by a method for manufacturing containers, particularly for liquids, more specifically for drinks, in accordance with the attached claims.

Further characteristics and advantages will appear more clearly from the detailed description of exemplary, and therefore not exclusive or limiting, embodiments of a method for obtaining a container in paper material for drinks. The invention will be described below with reference to the attached drawings, in which:

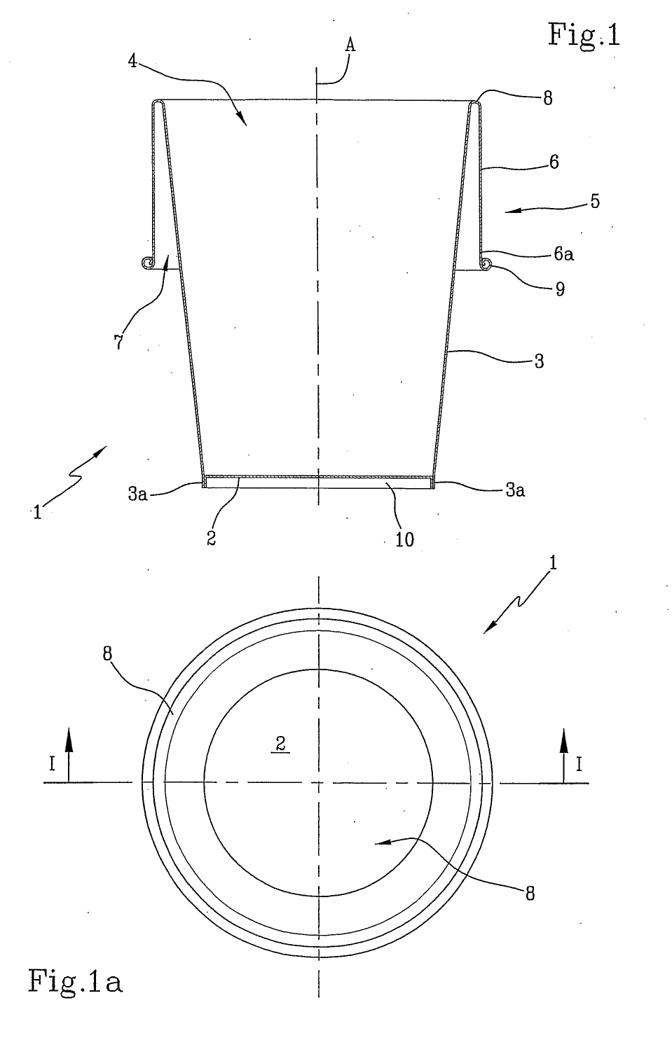

FIG. 1 illustrates, in longitudinal section, a beaker in paper material for hot drinks according to such methods, in accordance with the present invention;

FIG. 1a shows a view from above of the container shown in FIG. 1;

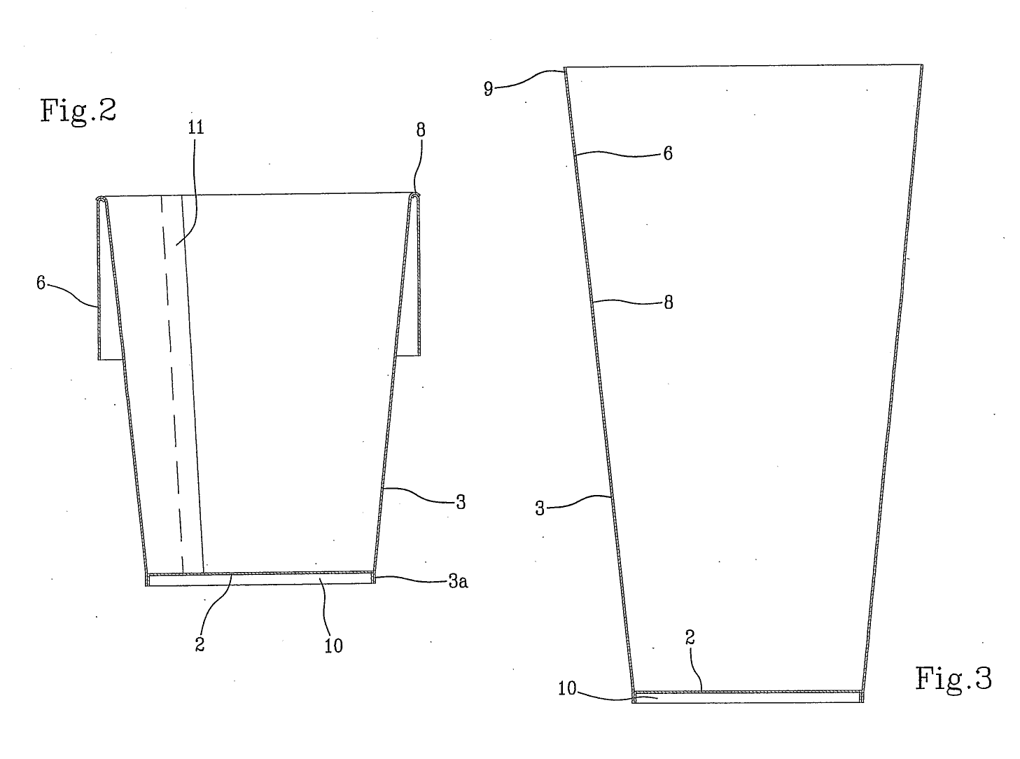

FIG. 2 illustrates, in longitudinal section, a beaker in paper material for hot drinks in accordance with a variant embodiment;

FIGS. 3-5 illustrate a temporal sequence of production steps aimed at obtaining the beaker shown in FIG. 1 according to a first method;

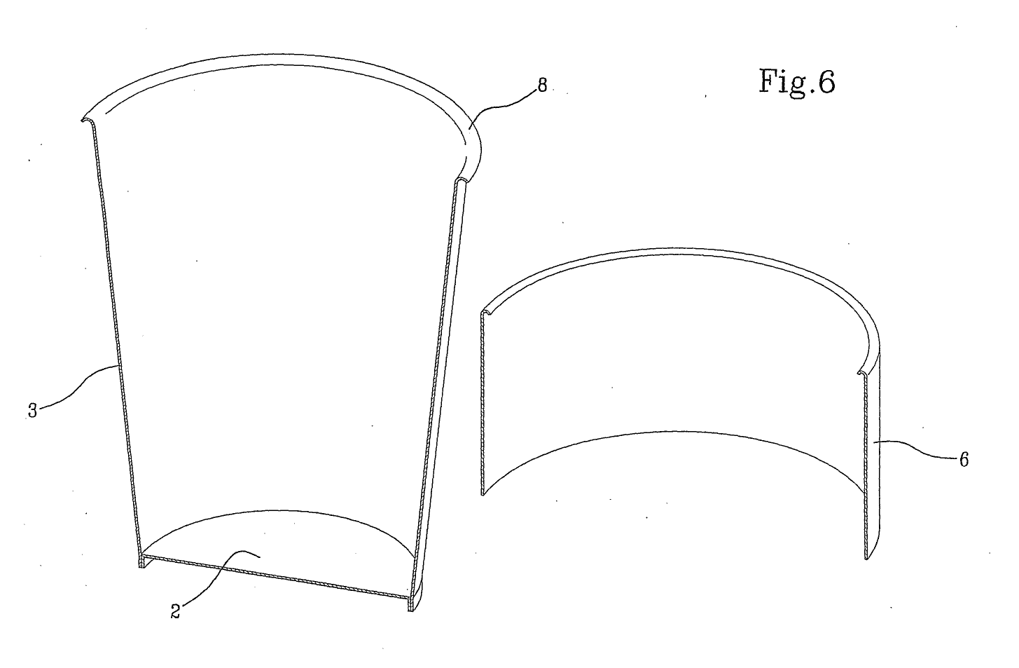

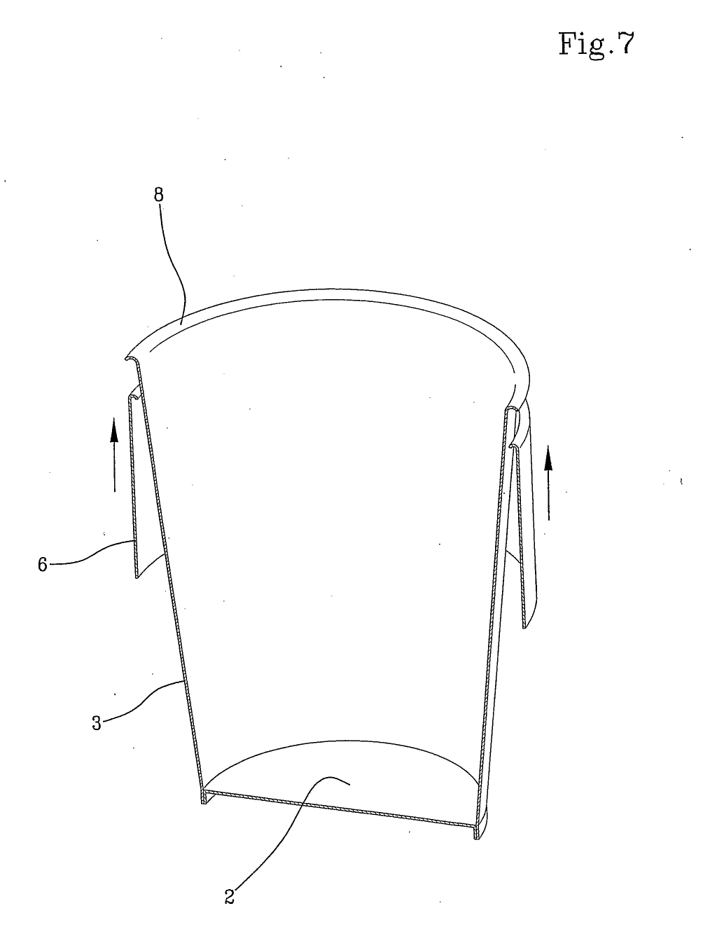

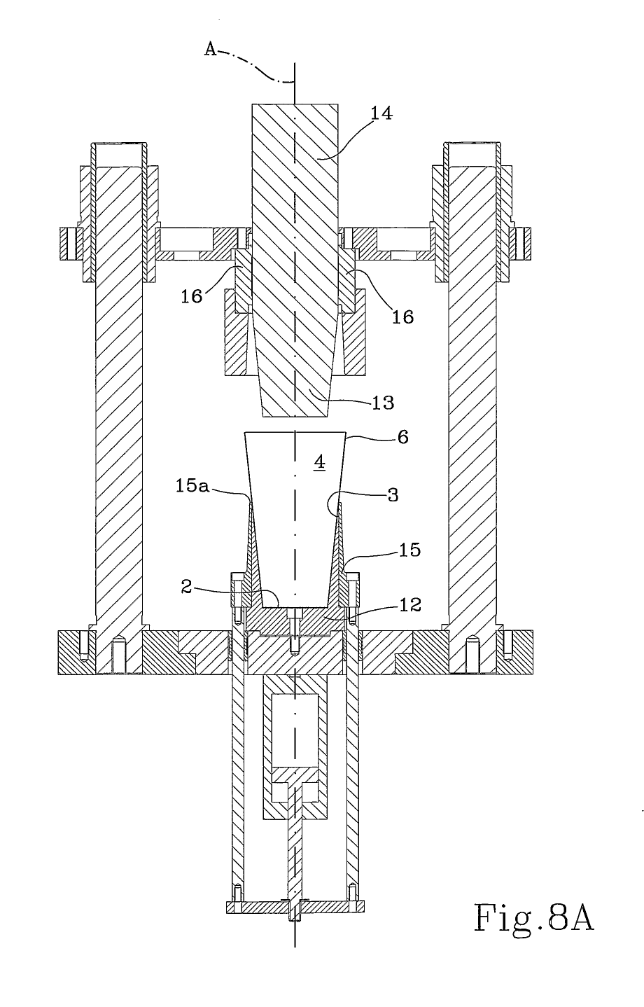

FIGS. 6 and 7 illustrate a temporal sequence of production steps aimed at obtaining the beaker shown in FIG. 2 according to a further method;

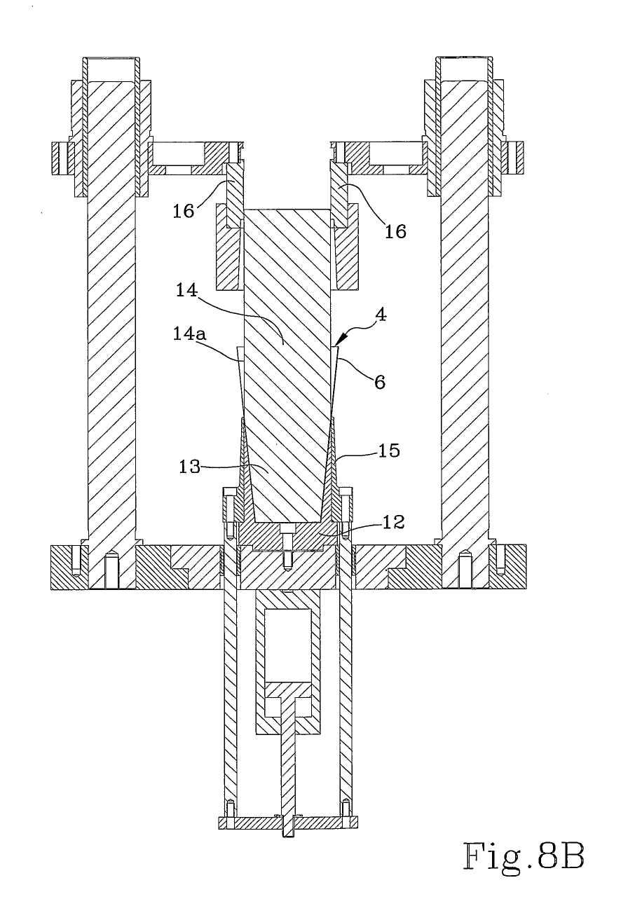

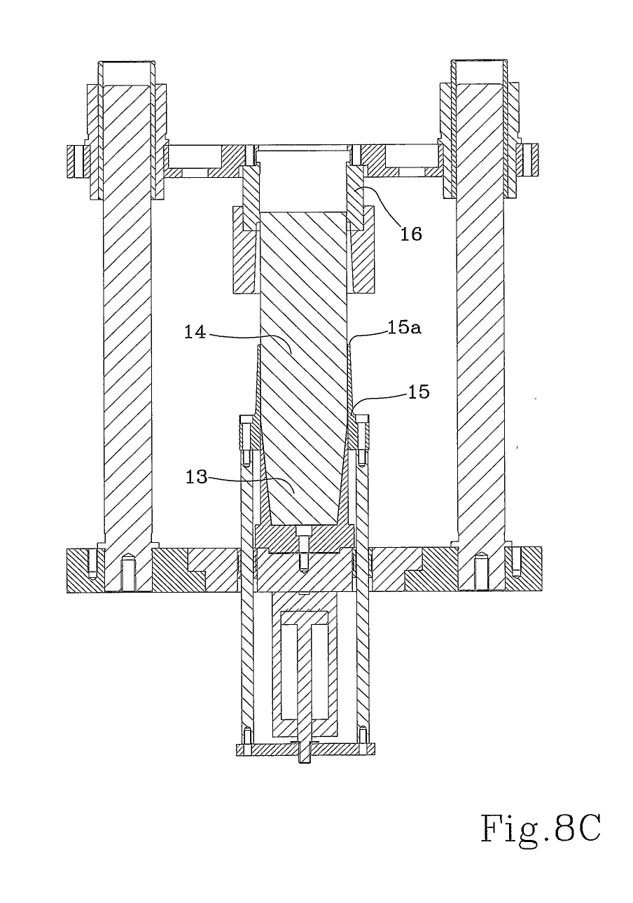

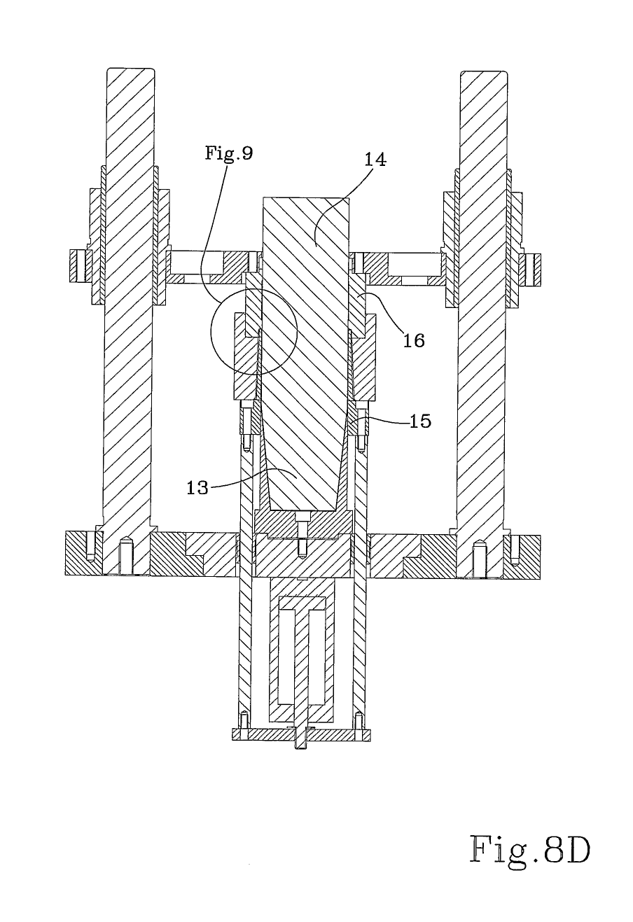

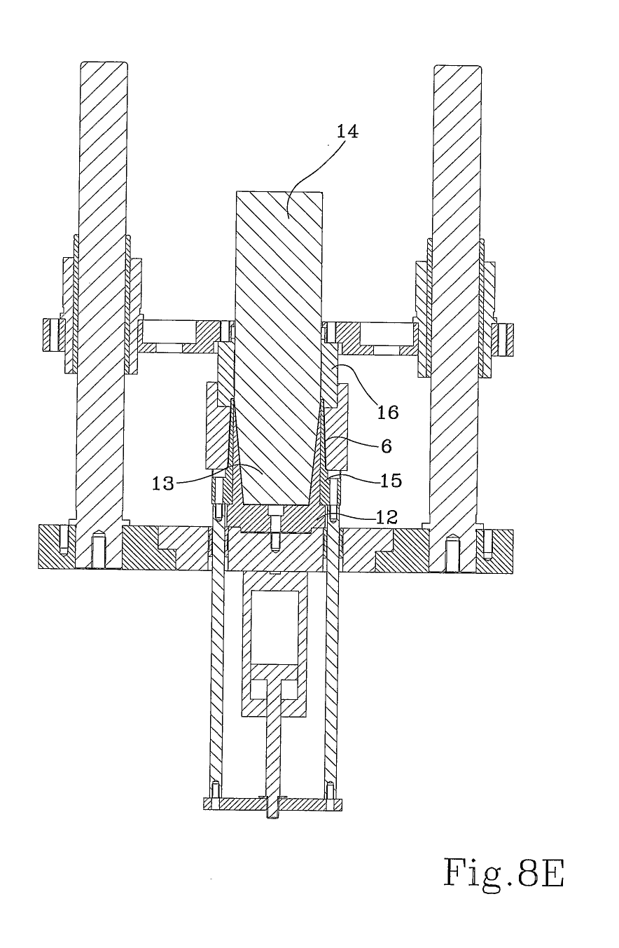

FIGS. 8A-8E illustrate a temporal sequence of production steps aimed at obtaining the beaker shown in FIG. 1 according to an alternative embodying method;

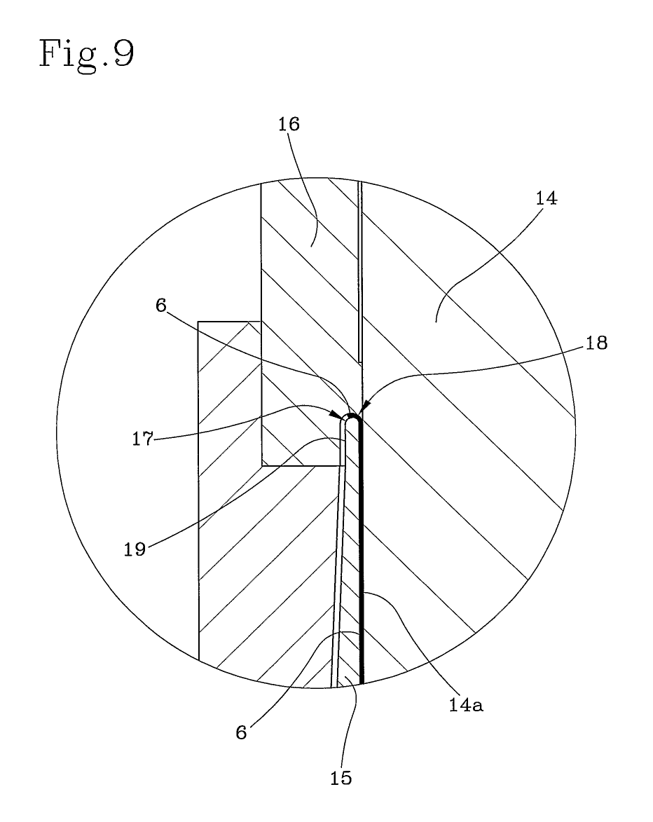

FIG. 9 shows an enlarged detail from FIG. 8D;

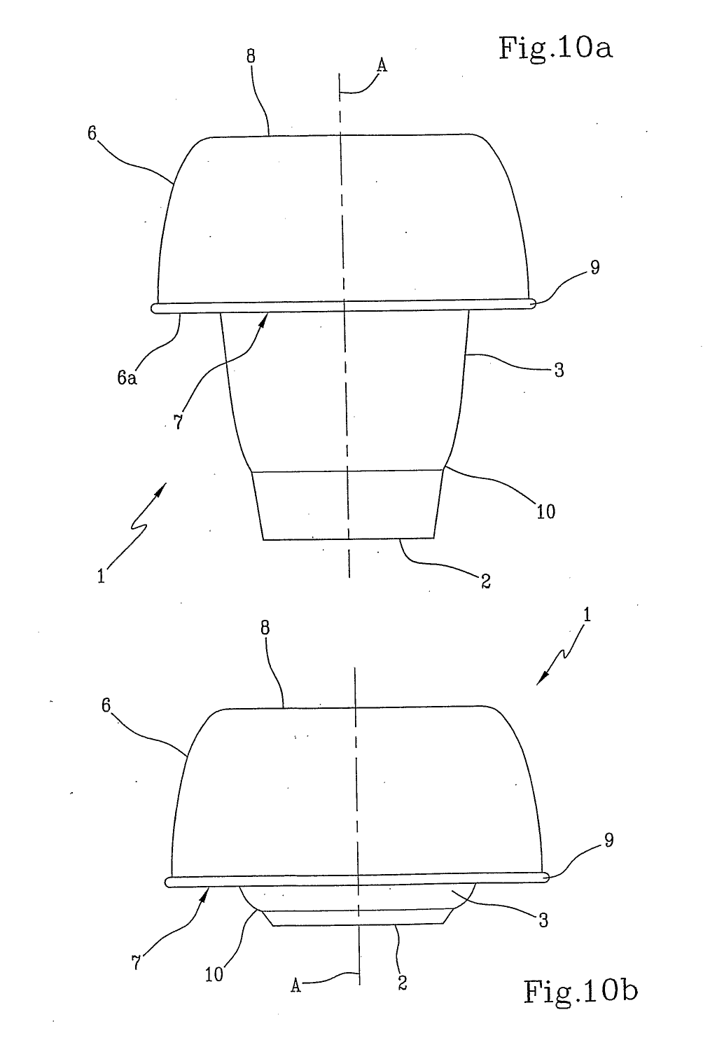

FIGS. 10a and 10b illustrate possible variant embodiments obtained using expandable paper;

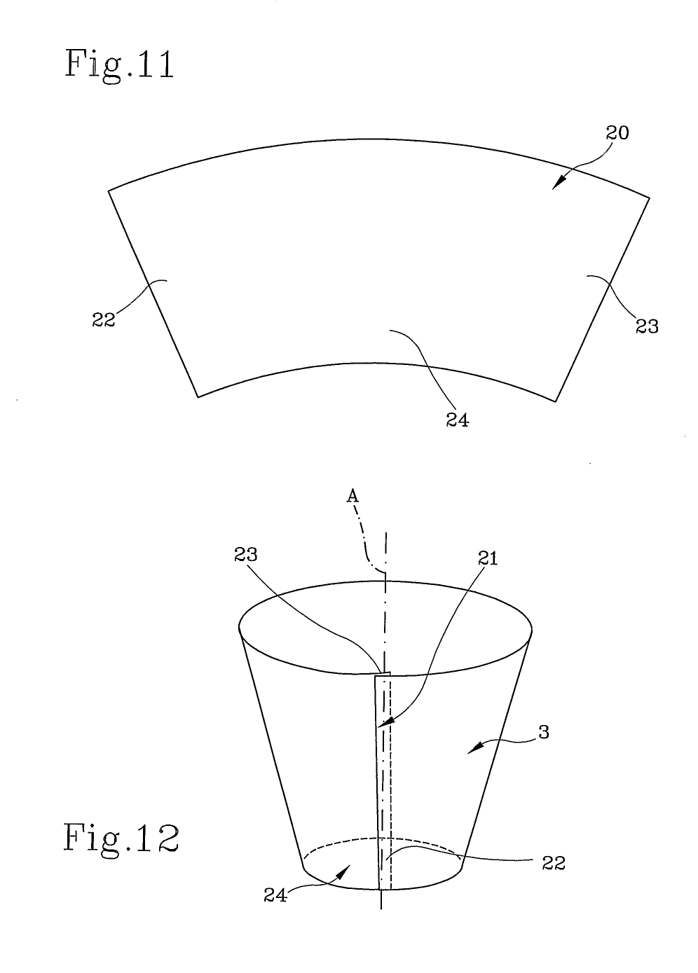

FIGS. 11 and 12 illustrate two preliminary steps in the manufacture of the lateral wall 3 of the container in accordance with the description;

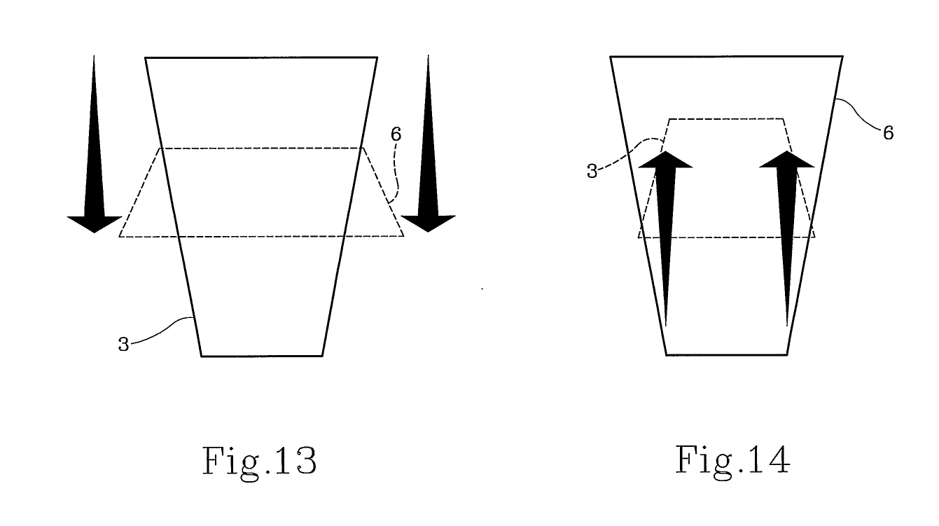

FIGS. 13 and 14 illustrate two possible steps in the manufacture of an external strip 6 in accordance with the production methods described;

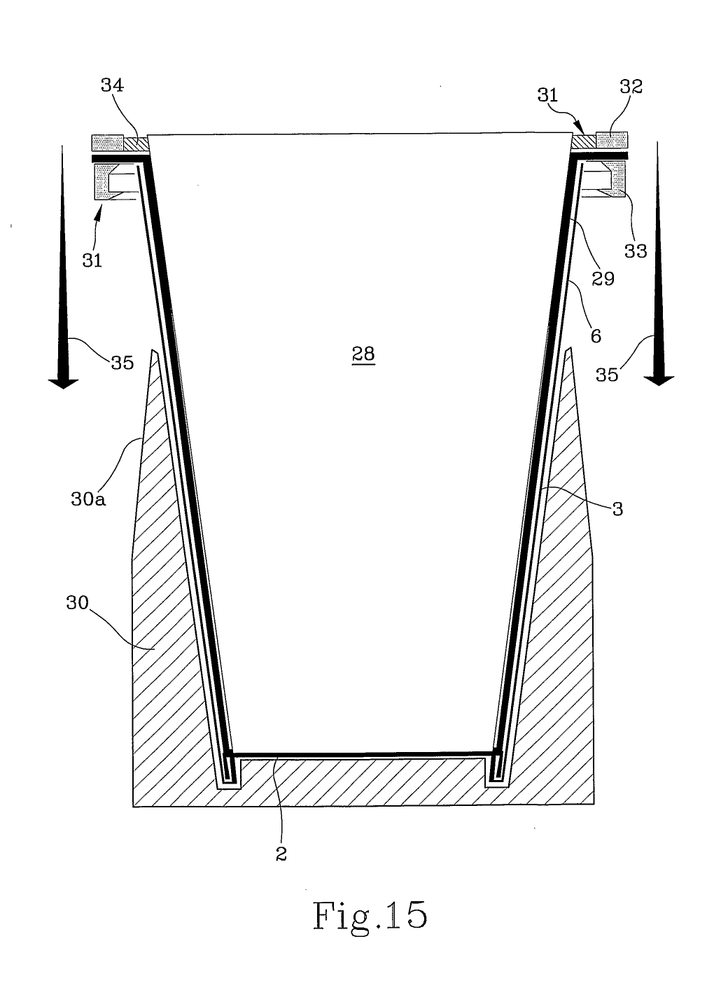

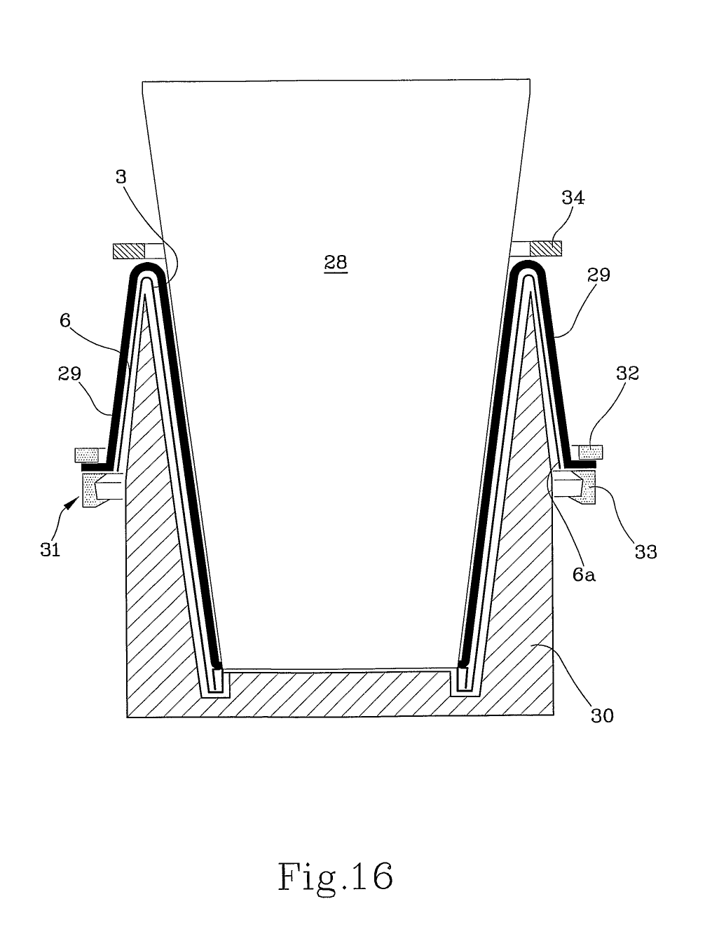

FIGS. 15 and 16 illustrate two steps in the manufacture of the container described below, using alternative production apparatus to that shown in FIGS. 8A-8E;

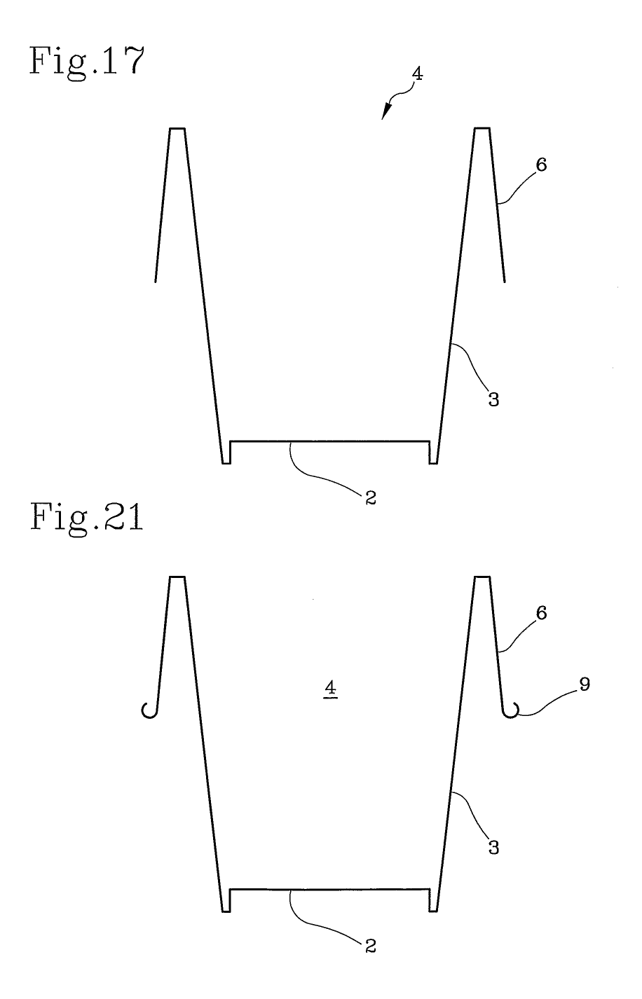

FIG. 17 shows the container manufactured with the apparatus shown in FIGS. 15 and 16;

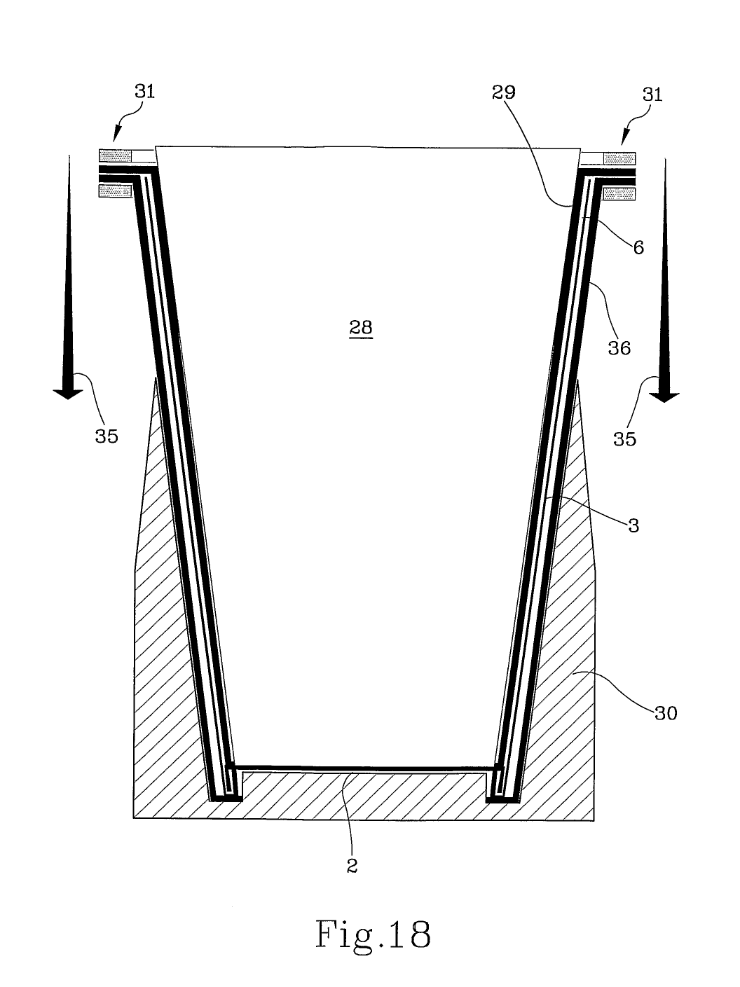

FIGS. 18-20 illustrate a variant embodiment of the apparatus shown in FIG. 15;

FIG. 21 shows the container manufactured with the apparatus shown in FIGS. 18-20;

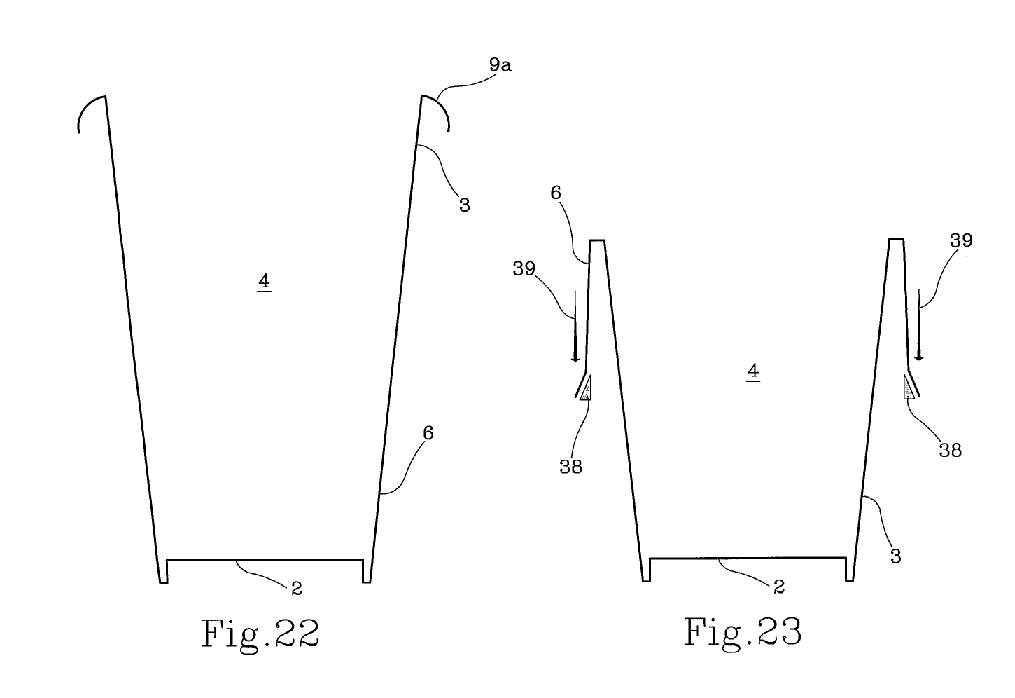

FIGS. 22 and 23 show a variant embodiment of the production method in accordance with the invention;

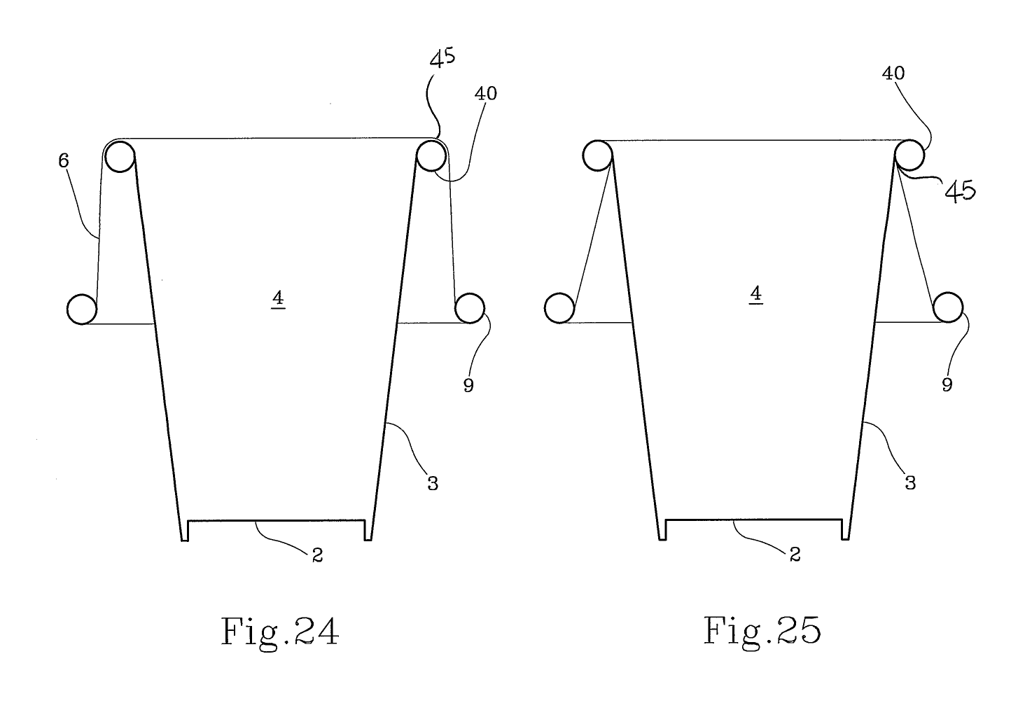

FIGS. 24 and 25 show two further configurations of the container in paper material described;

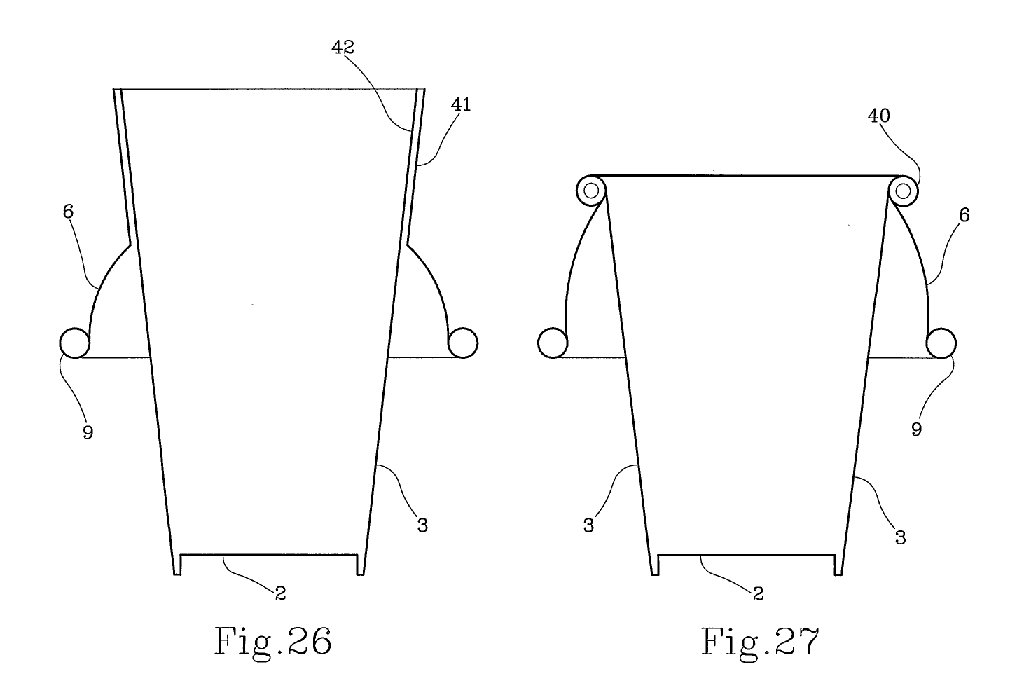

FIGS. 26-29 illustrate successive production steps relating to two different variant embodiments of the method according to the invention;

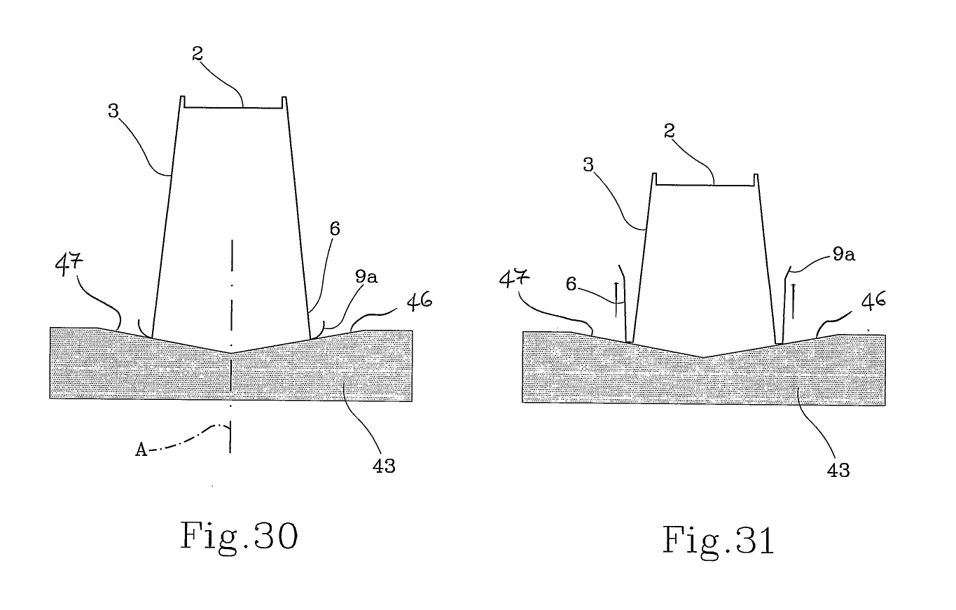

FIGS. 30 and 31 illustrate an alternative method for the production of a container in paper material according to the invention; and

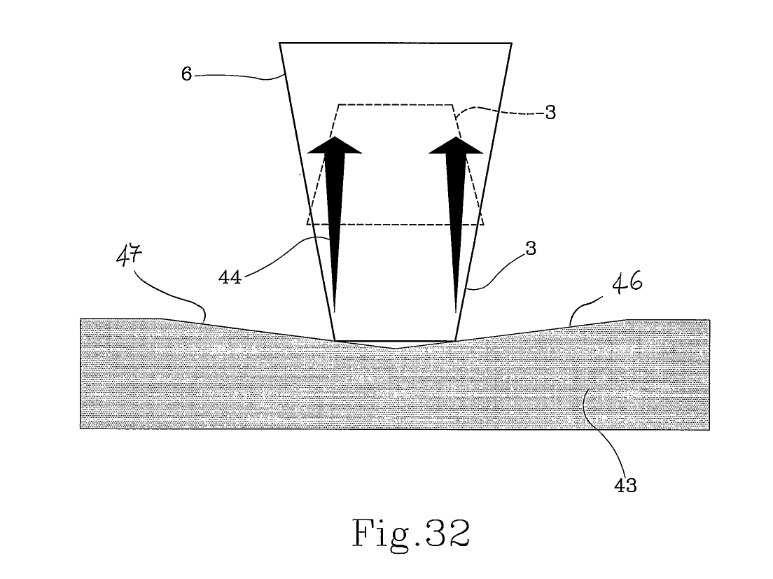

FIG. 32 shows a variant embodiment of the method shown in FIGS. 30 and 31.

With reference to the figures cited, no. 1 comprehensively indicates a container in paper material particularly indicated for foodstuffs and more specifically for liquids, such as drinks, and in particular a beaker for containing drinks, capable of allowing the consumption of hot or very hot drinks (tea, coffee, chocolate etc.), while handling the beaker itself without burning the hands. It is evident that the container will be suitable for containing any other substance, for example ice cream or polenta or yet other substances (possibly including non-food substances), allowing the user's hand to be thermally insulated with respect to the product contained. As may be noted by observing FIGS. 1, 2, 10a and 10b, the container may be seen to consist of a circular bottom wall 2 comprising a flat round portion and an edge 10 turned back downwards, transverse to the flat portion and destined to be irremovably coupled (by gluing or welding) to the lower area of the lateral wall 3. The lateral wall, consisting in general of a single sheet of paper material suitably folded and coupled, emerges from the bottom wall 2 and forms in cooperation with the latter a cavity 4 for containing the drink. To this end both the bottom wall 2 and the lateral wall comprise a food-grade plastic film coupled to the paper surface and directly in contact with the liquid (facing towards the inside of the above-mentioned cavity 4).

The lateral wall is generally of tapered shape (with a circular base), starting from a smaller dimension located at the bottom, and going towards the larger section located adjacent to the upper edge 8 of the container. It should be noted that both the bottom wall and the entire lateral wall are each formed from a single sheet of paper material. The container also has means 5 for allowing a user's hand to be thermally insulated, at least in part, with respect to the liquid contained in the cavity 4; in other words, the beaker which is the subject of the present invention is particularly suitable for the containment and consumption of hot/very hot drinks, preventing any problem connected with the manageability of the container which contains the hot liquid. These means 5 advantageously comprise an external strip 6 connected in the vicinity of the upper edge 8 of the container to the lateral wall 3 so as to form at the top a connected curved portion to rest against the consumer's mouth in order to prevent liquids spilling, thanks to its configuration free of sharp edges. The external strip 6 emerges from the round upper edge 8 and continues downwards for a length at least sufficient to allow the container to be manageable with one hand, thus constituting a gripping strip. To this end, and without limitation, the external strip may extend for at least a third of the height of the lateral wall 3, enveloping it completely along its entire circular extension. The external strip 6 joined to the lateral wall 3 and emerging and parting from the lateral wall itself and at the bottom forms an insulating airspace 7 between the external strip 6 and the lateral wall 3; this interspace appears open at the bottom and does not contain insulating inserts or anything else, because the insulation function is performed by the air within it. As mentioned above, the external strip has an extension sufficient to allow the container to be manageable with the hand without touching the lateral wall 3. The embodiments shown in FIGS. 1 and 2 differ in that, in the first case the lateral wall 3 and the external strip 6 are manufactured in one piece starting from a single material of paper sheet and are therefore clearly joined without loss of continuity and without any discontinuity or thickening of section. FIG. 2, on the other hand, represents a container in which the lateral wall 3 and the edge strip 6 are formed separately and are therefore joined in the area of the upper edge 8 by gluing (or heat-welding or similar system of irremovable bond); alternatively, the bond may be removable, for example by interlocking, as is shown in FIGS. 26-29 and subsequently clarified. The presence should be noted in this connection in FIG. 2 of an area of overlap in section of the outer and inner walls. The container shown in FIG. 1 furthermore has, in the area of the lower free edge 6a of the external strip 6, a reinforcing scroll 9 formed on the entire edge itself to increase its resistance to deformation by crushing the external gripping strip (forces in this direction are generated during handling of the beaker).

Obviously this scroll 9 may be absent (or have different shapes and geometries) depending on the requirements, the dimensions and the intended uses of the container. The external strip 6, too, may assume a tapered configuration (specifically, an inverted taper), starting with its smallest section at the upper edge 8 of the beaker and going towards its largest free section in the lower area. With this geometry, the insulating interspace 7 forms an isolating cushion of air, and the distance between the lateral wall 3 and the external strip increases as it goes from top to bottom.

This interspace 7 is empty and open at the bottom in the area of the free edge 6a of the external strip 6, so as to be able to receive by insertion the upper zone of another container (stackability). In short, the container is clearly perfectly stackable because there is no substantial thickening of the wall, nor undercuts such as to prevent the above-mentioned mutual coupling.

Obviously, other geometries will be possible for the lateral wall and the external strip, provided that the important characteristic of stackability is maintained.

The container also clearly has cylindrical symmetry with respect to the axis of extension A marked in the drawing. Given the description above which defines the technical characteristics of the product, there are various methods of producing it. Some of the possible (and most advantageous) production methods are set out below to highlight the constructional simplicity of the paper beaker. Obviously other equivalent production methods can alternatively be adopted without departing from the inventive concept of the present invention.

In its main essentials the production method in accordance with the present invention specifies an initial step of manufacturing at least one preliminary lateral wall 3 of tubular shape, forming a through cavity which will be the structure capable of forming, in its final embodiment, the lateral wall of the container.

In general the process will start from a flat blank 20 illustrated in FIG. 11 in the shape of a sector of a circle (in order to create a lateral wall of tapered shape).

The flat blank 20 will be suitably deformed until it assumes a tubular configuration illustrated in FIG. 12 which shows an area of overlap of the material 21.

In particular the end strips 22, 23 of the blank will be made to partially coincide: they will be overlapped in order to be irremovably bonded together, making a liquid-tight seal.

Carrying out this preliminary coupling step makes certain that the lateral wall will be liquid-tight because the bonding of the aforesaid overlap zone 21 by sealing or gluing is performed on a substantially flat surface and can therefore be automated, and the operation performed, with repeatability and extreme reliability.

At this point in the production stage it will be possible either to proceed, as more fully described below, to the manufacture of the external strip 6, or alternatively and in general preferably to couple the bottom wall 2 to the lower zone 24 to create a container of the type illustrated in FIG. 3.

It should be noted in this connection that the creation of the preliminary lateral wall 3 and the coupling of the latter to the bottom wall 2 can occur in a single and simultaneous production step, or again they can occur in successive production steps, according to requirements.

It should also be noted that in general all the production methods described below can be applied either to just the preliminary lateral wall 3, or alternatively to the finished preliminary container, i.e. equipped with lateral wall and bottom wall 2.

The sole exception is the method described in FIGS. 14 and 32, in which the turned-back edge strip 6 is formed by turning inwards and upwards a lower portion (indicated by 24 in FIGS. 11 and 12) of the preliminary lateral wall 3, i.e. the portion having the smallest section.

As mentioned above, a plurality of possible types of production will be set out below, particularly making (non-limiting) reference to the use, as a starting element, of a preliminary container of the type illustrated in FIG. 3.

The method for manufacturing containers in paper material which are particularly suitable for containing hot products generally comprises at least the steps of making a preliminary container in paper material which has a bottom wall 2 and a lateral wall 3 which emerges from the bottom wall, so that the bottom wall and the lateral wall form a containment cavity. In other terms, the first part of the procedure is to form a standard beaker-type container which however has a height greater than that of the finished beaker by a quantity equal to the length of the external strip 6; in other words the lateral wall of the initial container (FIG. 3) will have a height equal to that of the finished container plus the height of the external strip.

Subsequently, and not simultaneously with the creation of the preliminary container, the procedure continues with the preparation of the external strip 6 in paper material, joined to and emerging and parting from the lateral wall itself downwards, so as to form the above-mentioned insulating interspace between the external strip 6 and the lateral wall 3. In particular the external strip 6 forms a free lower outer edge, which is such as to leave open the insulating interspace 7 as previously described. It should be noted that the above-mentioned step of preparing the external strip comprises first of all an advantageous substep of turning the lateral wall 3 outwards and downwards in such a way that the material constituting the upper wall of the lateral wall of the preliminary container comes gradually to constitute the external strip 6.

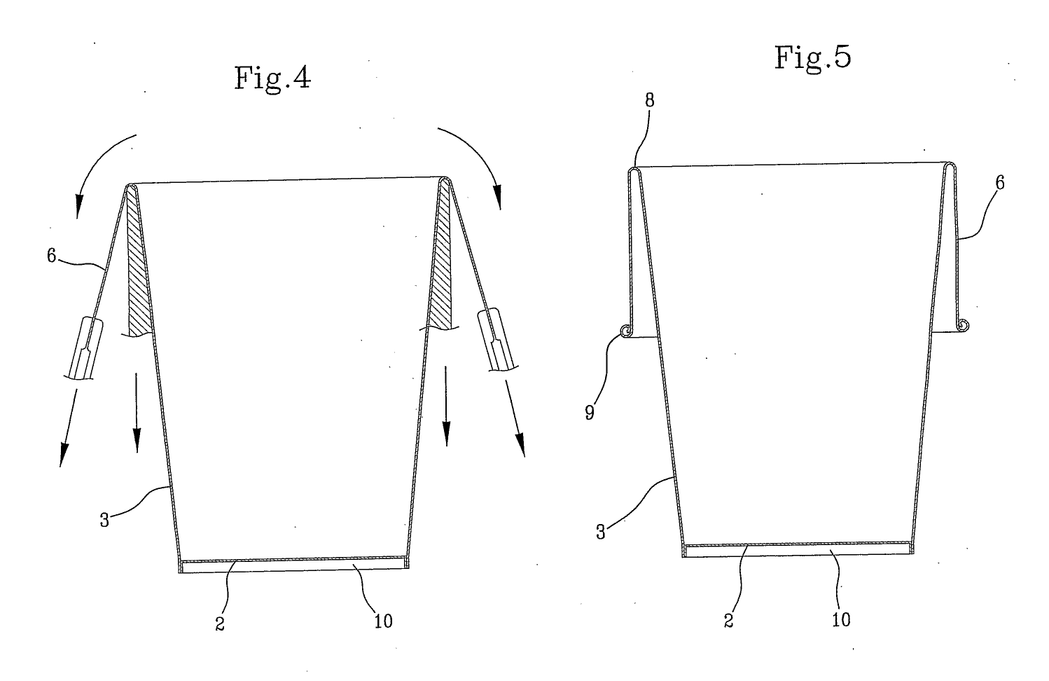

This is illustrated altogether schematically and by way of example in FIG. 4.

In a first manufacturing procedure, in order to implement the said method, and in particular to make it possible for the lateral wall to be turned outwards and downwards, it is necessary to devise a further substep of forming an excess of material at least in the area of the upper portion of the lateral wall 3 of the preliminary container, before performing this turning-down. This substep of forming an excess of material may for example comprise the provision (at least in the upper portion of the lateral wall) of expandable paper.

In fact this expandable paper makes it possible to have the excess of material, ensured by the expandability of the paper itself, which allows the paper to be turned back outwards without causing tearing or weakening of the paper material.

Alternatively, particularly when using ordinary paper (although this method could also be applied when using expandable paper where appropriate or necessary), the excess of material is formed by using a step of compressing the upper portion of the lateral wall of the preliminary container in the direction of the axis of symmetry A of the container. Observing in particular FIGS. 8A to 8E and 9, we note that they illustrate the successive stages of manufacture of the container by means of a suitable apparatus.

In the first place the already-formed container, shown in FIG. 3, is locked by the use of a first female die 12, counter-profiled along a portion, for example the lower portion, of the lateral wall. As is visible in FIG. 8, the first female die 12 in fact mates with the entire lower portion of the lateral wall (and possibly, if present, with the bottom wall). Locking the preliminary container is performed by the use of a first male die 13, counter-profiled at least to a portion, for example a lower portion, of the lateral wall. As may also be seen in FIG. 8A, the male die moves to mate perfectly with the female die, trapping the lower portion of the tapered lateral wall and the bottom wall 2. Still looking at FIG. 8A, we note the presence of a shaping element 14 which we find positioned inside the containment cavity 4, as is the first male die 13. In fact in the embodiment illustrated, the male die 13 and the shaping element 14 are made in one piece; in the alternative embodiment these elements could be made using distinct and cooperating elements. In detail, while the male die 13 conforms to and is counter-profiled to the corresponding portion of the preliminary container, shaping element 14 on the contrary forms a gap relative to the upper portion of the lateral wall 3, in particular relative to the part destined to form the turned-back edge strip. In the embodiment illustrated, the shaping element 14 is of cylindrical shape and comprises a surface 14a for receiving the paper material of the upper portion of the lateral wall 3, following compression over a circular area. In the more complex embodiment not illustrated, the surface 14a could be slightly tapered. The presence may also be noted of a compression body 15 designed to act on the upper portion of the lateral wall 3 of the preliminary container to compress said portion against the shaping element 14 in order to form the aforementioned excess of material. As is clearly visible in the sequence illustrated in FIGS. 8A-8E, the compression body 15 is made to slide from the bottom upwards (i.e. from the bottom wall towards the upper portion of the lateral wall, moving to cooperate with the shaping element 14 in order to bring the upper portion of the lateral wall 3 from the tapered configuration to a cylindrical configuration as shown in FIG. 8C). In the configuration shown in FIG. 8C it is possible to initiate the substep of turning back the lateral wall 3 outwards and downwards. In particular an upper guide body 16 and a lower guide body 15 are provided for the purpose. In the case illustrated, the lower guide body 15 coincides with the compression body previously mentioned. In other words, the upper and lower guide bodies 15, 16 cooperate to form a shaping interspace 17 capable of allowing the upper portion of the lateral wall to pass through and to be turned back downwards.

In detail, while the male and female dies 13, 12 are fixed and do not hold the container in position, the upper and lower guide bodies 15, 16 are jointly movable downwards and active on the upper portion of the lateral wall in order to force it to make an inverting movement outwards. As may be noted from the figures cited, the upper guide body 16 has a shaping area 18 with a curved and concave conformation; correspondingly, the lower guide body 15 has a corresponding shaping area 19 with a curved but convex conformation. The distance between said concave and convex shaping areas 18, 19 form the aforementioned interspace 17. It should be noted that optionally, during the movement of the upper and lower guide bodies 15, 16, the dimensions of the interspace 17 can be varied; in particular it is advantageous to have a reduction in the axial dimensions (according to axis A) of the shaping interspace 17 during its downward movement. By proceeding appropriately step by step as illustrated in FIG. 9, we proceed to a progressive turning back of the lateral strip 6, making use of the excess of material previously formed by means of the compression step. Having created the aforementioned excess of material it is possible to turn the paper back outwards without creating lacerations, which would by contrast have been impossible to avoid if using normal, non-expandable types of paper.

In an alternative embodiment of apparatus to manufacture the container described, provision is made to adopt a suitable female die 30 which is at least partially counter-profiled to a lower portion of the preliminary container itself (in this case, too, it will be possible either to proceed with just the preliminary lateral wall 3 formed, or alternatively to create a beaker already equipped with a sealed bottom).

An element 29 made of flexible material (such as for example rubber, fabric, a flexible film or something else again) is inserted into the preliminary container.

A suitable core 28 made of rigid material, steel for example, of the same dimensions and shape as the flexible material 29, is inserted inside the aforementioned cone in such a way as to mate with the internal surface of the preliminary container in paper material, as is clearly shown in FIG. 15.

In other words, the apparatus depicted in this drawing rigidly locks the lower portion of the preliminary container (i.e. the bottom wall 2 and the portion destined to form the lateral wall 3 of the finished container illustrated in FIG. 7).

The female die 30 will leave free an upper portion 6 of the preliminary lateral wall, which is destined to form the aforementioned external strip.

The two free upper portions of the lateral wall 3 of the preliminary container and of the element in flexible material 29 are fixed solidly to each other by means of the use of suitable gripping means 31.

FIG. 15 illustrates gripping means consisting of a principal upper flange 32, a secondary lower flange 33 and an auxiliary flange 34.

During the stages of manufacturing the container, the procedure includes moving the gripping means 31 downwards in the direction of arrows 35 in FIG. 15.

In the subsequent step illustrated in FIG. 16 we note that the external strip of the container in paper material has been turned back downwards so that it moves to mate with a corresponding shaping surface 30a of the female die 30, the strip 6 being interposed between the aforementioned shaping surface of the female die 30 and the element in flexible material 29.

In particular the gripping means 31, i.e. in this case the principal flange and the secondary flange 32, 33 can be seen to be still locked onto the upper portion of the container in paper material which has, at this point, become the free lower edge 6a of the external strip 6. In other words again, a conical core is inserted into a cone of the same dimension and shape of flexible material.

The paper cone is fitted onto the already assembled foregoing parts, and the paper and the cone in flexible material are lowered simultaneously together.

The original edge is held in order to avoid the paper creasing and, at the point of arrival, the inverted portion meets a counter-cone of the corresponding dimension and slope.

In an alternative variant embodiment, illustrated in FIGS. 18-20, there is a further element in flexible material 36 which is interposed between the female die 30 and the container in paper material to be deformed.

In particular an upper portion of the further element in flexible material 36 is suitably locked by the aforementioned gripping means 31.

In the configuration shown in FIG. 18 we note that the preliminary container in paper material is substantially and entirely contained inside the two aforementioned elements in flexible material 29, 36.

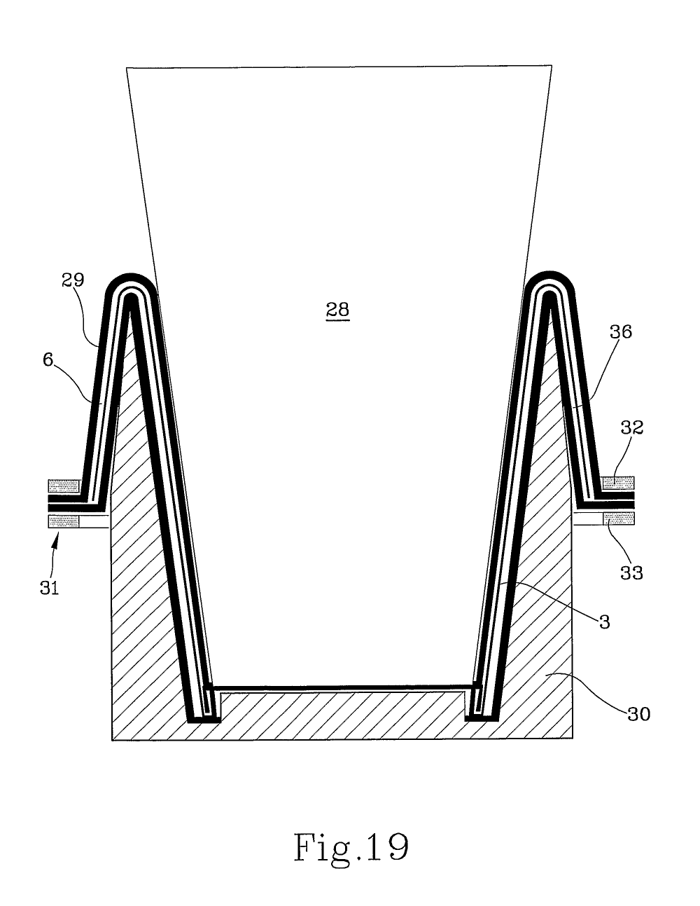

As in the previous case, provision is made for moving the gripping means 31 in the direction of arrow 35 in FIG. 18, taking them to the turned-back configuration of FIG. 19.

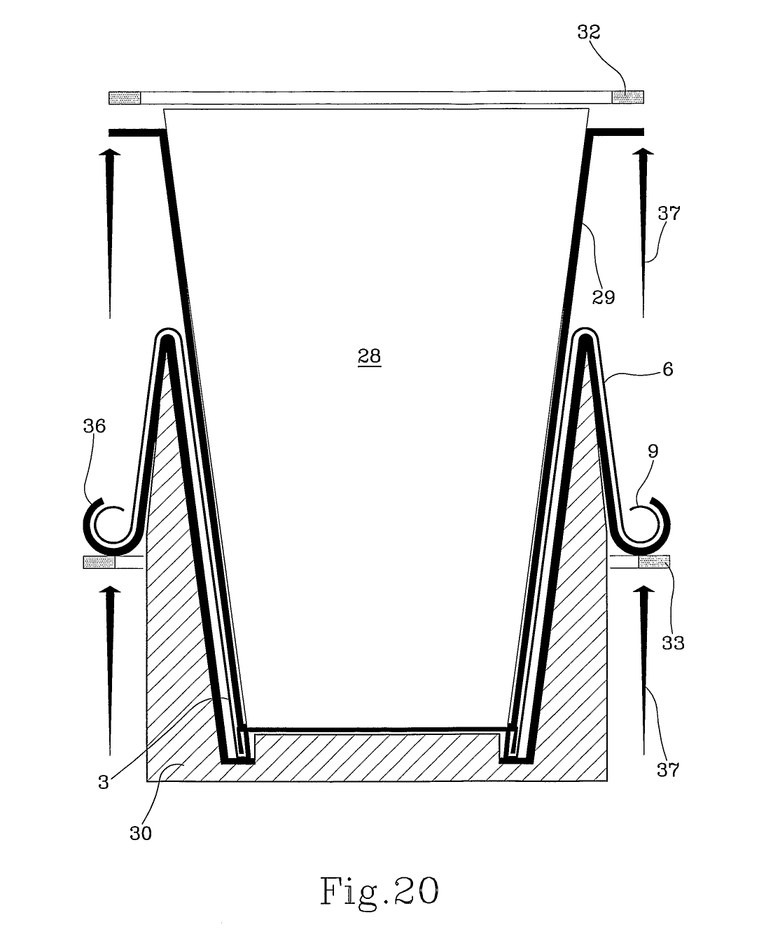

At this point provision is made to move the first element in flexible material 29 upwards as shown in FIG. 20.

By then moving the further element in flexible material 36 upwards in the direction of arrows 37 in FIG. 20, by means, for example, of the secondary flange 33, we ensure that the scroll 9 is formed as illustrated.

In other words, the container of the type shown in FIG. 21 will have been created.

To put it in other terms: as in the preceding system, the paper cone to be inverted is fitted onto the conical core, which is covered in its turn with a cone of flexible material.

Around it is fitted a further cone in flexible material (so that the paper is between two cones of flexible material) and the procedure as illustrated and previously described is followed; while the upper edges of both the cones in flexible material, which are slightly longer than the paper cone, are kept together (for example with a ring), the second outer cone further facilitates the descent of the cone to be inverted.

At the point of arrival, the inverted portion meets a counter-cone of the corresponding dimension and slope.

In this situation, the cone in flexible material is raised by just the distance necessary to create the scroll which normally forms the edge of a beaker.

Obviously the flexible material outside the paper can be deeper if it is desired to distance the external strip further in order to favour stacking.

In a further embodiment illustrated in FIGS. 22 and 23, the first step in the procedure is to form an outward lip 9a at the upper edge 8 of the lateral wall 3.

The lip 9a is gripped by suitable locking means 38 which are translated downwards in the direction of the arrows 39 in FIG. 23, thus forming the aforementioned external strip 6.

In other words, the beaker's upper edge which is to be inverted is predisposed for the beginning of a scroll with traditional methods, and is locked with two rings to prevent it from creasing further.

Subsequently the two rings are made to descend by exerting an even force, thus inverting the desired portion of the initial beaker.

It should be noted that in the same manner (not depicted) it would also be possible to raise the lower edge of the lateral wall of the beaker itself, while in this case keeping the two rings holding the edge stationary.

FIGS. 30-32 illustrate a further production method.

In this case, too, provision is made initially for creating an outward lip 9a at the upper edge (FIG. 30) or the lower edge (FIG. 32) of the preliminary lateral wall.

A rotating plane 38 is then set up, particularly having shaped surfaces 46, 47, inclined towards the axis of rotation A.

In particular the rotating plane has conical concavities equivalent to the inclination of the cone itself.

The preliminary lateral wall 3 is positioned on the rotating plane with its axis of extension A coinciding with the axis of rotation.

At this point the external strip is formed (FIG. 31) by moving together the preliminary lateral wall and the rotating plane 38 along axis A.

It is evident that the same procedure can be implemented on a preliminary container as illustrated in FIG. 30 or also on just the preliminary lateral wall as illustrated in FIG. 32, by acting either on the wider upper edge of the lateral wall (FIG. 30), or on the narrower lower edge of the same preliminary lateral wall (FIG. 32).

In other words, the cone to be inverted is pushed against a rotating concave cone, exerting light pressure.

This rotating cone has a conical concavity equivalent to the inclination of the cone itself, and before the cone descends under pressure onto the rotating concave cone, the corresponding edge is predisposed for the start of a scroll, using traditional methods.

In a different manufacturing procedure (FIGS. 6 and 7 and 24-29) which can be adopted for creating the container shown in FIG. 2, provision is made for separately assembling the base wall 2 with the lateral wall 3 and then coupling thereto the external strip 6.

Once a normal paper beaker is assembled, the tapered external strip which has already been produced is connected to it irremovably or by interlocking. In the detail in FIGS. 6 and 7, the annular external strip is coupled irremovably to the preliminary container at the upper edge 8 of the lateral wall 3 itself. This coupling step provides for the attachment of the zone with the smallest section of the tapered strip to the upper edge of the lateral wall.

The upper edge of the external strip 6 can be inserted under the scroll on the upper edge of the beaker, or gluing can be used on coupled partially counter-profiled surfaces as shown in FIG. 7. It is also evident that, depending on requirements, the reinforcing scroll 9, if present, is formed in the standard way and with standard technology.

With reference to the embodiment shown in FIG. 24, the coupling step is performed by irremovably bonding the end portion 45 at the top to the scroll 40 which is present at the upper edge 8 of the lateral wall 3, or, according to the embodiment shown in FIG. 25, by bonding an end portion 45 underneath said scroll 40, either irremovably or by interlocking.

In a further variant embodiment shown in FIGS. 26 and 27, the already-formed annular external strip is positioned at the upper edge 8 of the lateral wall 3.

A part of said upper edge is curled to obtain a scroll comprising material from said lateral wall 3 and from said annular external strip, thus forming a coupling between external strip and preliminary container.

In this way, if desired, it is possible to avoid any kind of gluing or welding, while ensuring the bond between the external strip 6 and the container by mechanical coupling thanks to the scroll 40.

It should be noted, moreover, that by adopting the use of expandable paper it will be possible to form an inverted cone which not only fits with the conical starting shape, but also has a deformation which will allow greater distancing and perfect stacking between the beakers thus produced.

As illustrated in FIG. 26, the external strip in fact has a tapered upper portion 41 and a lower portion with a curved outline parting from the lateral wall 3, this portion being provided on its underside with a reinforcing scroll 9.

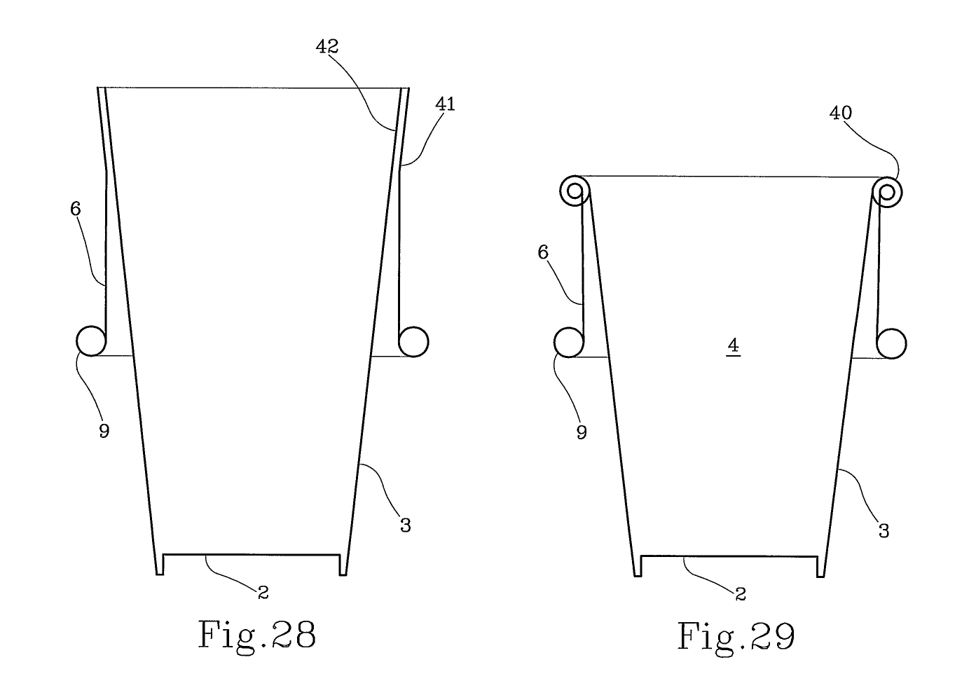

The embodiment shown in FIGS. 28 and 29 provides for the use of an external strip of cylindrical shape, made of expandable paper.

The upper portion 41 is coupled to and mates with the tapered section of the beaker, and the bond is obtained as in the previous method by forming the scroll 40.

The finished container illustrated in FIG. 29 has a cylindrical lateral strip 6.

It should be noted that by making the container in paper material in two pieces it is possible to have a controlled divergence of the external strip, and insulation according to requirements (more or less distanced from the lateral wall 3), and that the container can be produced using the same existing machines.

It should be noted in general that the inversion of a portion of the cone, starting from an already-formed cone, possibly already made into a beaker with a bottom, can be performed either separately with traditional methods, or directly, before inversion.

The materials can be either traditional paper and/or cardboard and/or expandable paper, particularly with a degree of expandability not less than 5%, with or without waterproofing additives or adjuncts.

It is evident that all the exemplary embodiments illustrated can specify the use of standard or expandable papers. In the latter case it is possible to intervene at the implementation stage with further shaping and details for the container, to exploit the aforementioned stretchability of the material (for example rounded shapes which are not obtainable with normal papers). In this connection FIGS. 10a and 10b illustrate some possibilities for modifications to the geometry with respect to the containers shown in FIGS. 1 and 2, which are obtainable by using the aforementioned expandable paper. It will for example be possible to achieve modifications to the geometry of the lateral wall 3 by deformation, so that the latter has a partially curved outline 10, as is evident in the drawing. An external strip 6 that is rounded in section can also be introduced. In detail, FIG. 10a illustrates a beaker; FIG. 10b, on the other hand, shows a small cup. It is evident that the embodiment shown in FIG. 2 can be created using expandable paper (which is more expensive) for the external strip only, in order to endow the latter with particular shapes.

The invention achieves important advantages. First of all, the beaker obtained with the methods which are the subject of the invention proves to be the first solution which allows the hot contents to be thermally insulated using in section a single sheet of paper material. This brings considerable savings in materials and reduced production costs with very competitive timescales. Said beaker can be seen to be structurally strong and sufficiently rigid in use, while isolating the consumer's hands, but at the same time maintaining excellent stackability which is necessary for purposes of transport and storage of the products. The mouth of the container can be seen to be identical to that of a normal beaker and enables spillages of liquid to be avoided during its consumption. The proposed manufacturing processes are easily industrializable and are simple, with consequent containment of the costs of the product. Finally, following experimental trials it has been seen that the configuration adopted ensures better maintenance of the temperature of the drink. In this way it is possible either to keep the drink hot for longer or to serve it not very hot and ready for immediate consumption while still ensuring that it remains at optimum temperature.

1-33. (canceled)

34. A method of manufacturing a container of paper material comprising the steps of manufacturing a preliminary lateral wall of tubular shape and of paper material, forming an internal cavity, wherein the method also comprises a step, subsequent to the manufacture of the preliminary lateral wall, of predisposing an external strip of paper material, joined to the lateral wall and emerging and parting downwards from the lateral wall so as to form an insulating interspace between the external strip and the lateral wall, the external strip forming a free lower edge such as to leave open said insulating interspace.

35. The method according to claim 34, wherein said step of manufacturing a preliminary tubular lateral wall comprises a substep of shaping a blank until the blank assumes a tubular configuration having an overlap zone of end strips of the blank, said substep of shaping a blank being a substep of shaping a flat blank in the shape of a sector of a circle, and a substep of bonding of said strips to each other, said substep of bonding being a substep of bonding to form a liquid-tight seal of said strips to each other.

36. The method according to claim 34, further comprising a step of bonding a bottom wall to the preliminary lateral wall of tubular shape, to form a preliminary container of paper material having a containment cavity, and wherein the step of manufacturing a preliminary lateral wall comprises the manufacture of a preliminary lateral wall of tapered shape.

37. The method according to claim 34, wherein the step of manufacturing a preliminary lateral wall of tubular shape provides for the creation of a preliminary lateral wall arising for a height greater than that of the lateral wall of the finished container, and wherein the step of predisposing an external strip comprises the substep of turning the lateral wall back outwards and downwards so that the material constituting the upper portion of the preliminary lateral wall comes step by step to constitute the external strip.

38. The method according to claim 37, wherein the step of manufacturing the preliminary lateral wall provides for the creation of a lateral wall emerging for a height greater than that of the finished container, and wherein the step of predisposing an external strip comprises the substep of turning the lateral wall back outwards and downwards so that the material constituting the upper portion of the lateral wall of the preliminary container comes step by step to constitute the external strip.

39. Method according to claim 38, wherein the substep of turning the lateral wall back outwards and downwards comprises:
predisposing an upper guide body;
predisposing a lower guide body;
said upper and lower guide bodies cooperating to form a shaping interspace configured to allowing the upper portion of the lateral wall to pass through and to be turned back downwards, the upper and lower guide bodies being simultaneously active on said upper portion of the lateral wall and moving jointly relative to the container and in the direction of the bottom wall, in order to progressively turn back the upper portion, and wherein the upper guide body has a shaping area with a concave curved conformation, and the lower guide body has a corresponding shaping area with a convex curved conformation, the distance between said concave and convex shaping areas forming said interspace.

40. The method according to claim 34, comprising the steps of manufacturing a preliminary container of paper material having a bottom wall, the preliminary lateral wall emerging from the bottom wall, said bottom wall and said preliminary lateral wall forming a containment cavity, and comprising furthermore a step, subsequent to the manufacture of the preliminary container, of predisposing an external strip of paper material, joined to the lateral wall and emerging and parting downwards from the lateral wall itself so as to form an insulating interspace between the external strip and the lateral wall, the external strip forming a free lower edge such as to leave open said insulating interspace.

41. The method according to claim 34, wherein the step of predisposing an external strip comprises a substep of forming an enrichment of material at least in the area of an upper portion of the lateral wall before the substep of turning the upper portion back.

42. The method according to claim 41, wherein the substep of forming an enrichment of material comprises a compression at least of the upper portion of the lateral wall of the preliminary container towards an axis of symmetry of the lateral wall, the lateral wall having a substantially tapered outline broadening out from the bottom in the direction of the opening of the internal cavity.

43. The method according to claim 42, wherein the compression step comprises:
positioning the preliminary lateral wall, or the preliminary container, in a first female die, counter-profiled at least to a portion of the lateral wall;
locking the preliminary lateral wall, or the preliminary container, by means of a first male die, counter-profiled at least to a portion of the lateral wall, a shaping element being placed inside the containment cavity; and
providing a compression body acting on the upper portion of the preliminary lateral wall to compress the latter against the shaping element in order to form the aforementioned enrichment of material, wherein the shaping element comprises a surface receiving the paper material of the upper portion of the lateral wall, said surface being substantially cylindrical or slightly tapered.

44. The method according to claim 43, wherein the compression body acts by sliding in a direction from the bottom wall towards the upper portion of the lateral wall to compress the latter against the shaping element, an upper neck of the compression body mating with the surface receiving the paper material of the shaping element.

45. The method according to claim 41, wherein the substep of forming an enrichment of material comprises the predisposition at least of the upper portion of the lateral wall in expandable paper.

46. The method according to claim 34, wherein the step of manufacturing a preliminary container provides for the creation of a container with a preliminary tubular lateral wall with a height greater than that of the lateral wall of the finished container, and wherein the step of predisposing an external strip comprises the substep of turning the lateral wall outwards and downwards so that the material constituting the upper portion of the preliminary lateral wall comes step by step to constitute the external strip.

47. The method according to claim 34, wherein the step of manufacturing a preliminary lateral wall provides for the creation of a preliminary lateral wall emerging for a height greater than that of the finished container, and wherein the step of predisposing an external strip comprises the substep of turning the tubular preliminary lateral wall inwards and upwards.

48. The method according to claim 34, wherein the step of predisposing an external strip comprises the substeps of:
inserting the preliminary container into a female die at least partially counter-profiled to a lower portion of the preliminary container itself;
inserting into the preliminary container an element in flexible material;
inserting into the preliminary container a core substantially counter-profiled to the preliminary container, said element in flexible material being interposed between the preliminary container and the core;
fixing an upper portion of the lateral wall of the preliminary container and an upper portion of the element in flexible material by means of gripping means;
turning the lateral wall back outwards and downwards using the gripping means so that the material constituting the upper portion of the preliminary lateral wall comes step by step to constitute the external strip.

49. The method according to claim 48, comprising furthermore the substeps of:
inserting the preliminary container into a further element of flexible material, said further element of flexible material being interposed between the preliminary container and the female die.

50. The method according to claim 49, wherein, after having turned the lateral wall back outwards, the steps are specified of releasing the element in flexible material from the gripping means and distancing the element in flexible material from the external strip and of partially raising the further element in flexible material to form a scroll on said external strip.

51. The method according to claim 34, wherein the step of predisposing an external strip comprises the substeps of:
forming a lip outwards at the upper edge of the lateral wall;
fixing said lip using locking means;
turning the lateral wall back outwards and downwards using the locking means so that the material constituting the upper portion of the preliminary lateral wall comes step by step to constitute the external strip.

52. The method according to claim 34, wherein the step of predisposing an external strip comprises the substeps of:
predisposing a rotating plane having shaped surfaces inclined towards the axis of rotation;
positioning the preliminary lateral wall on said rotating plane with its axis of extension coinciding with the axis of rotation, and
moving said preliminary lateral wall and said rotating plane closer along the axis to form said external strip, and wherein the step of predisposing an external strip comprises the further substep of forming a lip outwards at the upper edge of the preliminary lateral wall.

53. The method according to claim 34, wherein the step of predisposing an external strip comprises the substeps of:
separately creating an annular external strip;
coupling said annular external strip either irremovably or by interlocking to the preliminary container at an upper edge of the lateral wall.

54. The method according to claim 53, wherein the step of creating the annular external strip provides for the creation of a tapered external strip, the coupling step providing for the attachment of the zone with smallest diameter of the tapered strip to the upper edge of the lateral wall.

55. The method according to claim 53, wherein the step of coupling the annular external strip of the preliminary container is performed by irremovably bonding an end portion at the top to a scroll which is present at the upper edge of the lateral wall, or by bonding, irremovably or by interlocking, an end portion at the bottom to said scroll.

56. The method according to claim 53, wherein the coupling step provides for the substeps of:
positioning the annular external strip at the upper edge of the lateral wall;
curling a part of said upper edge to obtain a scroll comprising material from said lateral wall and from said annular external strip, thus forming a coupling between external strip and preliminary container.

57. The method according to claim 53, wherein the step of creating the annular external strip provides for the creation of a tubular cylindrical external strip, the coupling step providing for the attachment of the upper zone of the cylindrical strip to the upper edge of the lateral wall.

58. An apparatus for manufacturing a container in paper material comprising:
a female die configured for receiving at least one preliminary lateral wall of tubular shape having a bottom wall and a lateral wall arising from the bottom wall, said bottom wall and said lateral wall forming a containment cavity;
a male die configured for being inserted inside said preliminary lateral wall to lock, in cooperation with the female die, at least one lower portion of the preliminary lateral wall; and
an upper guide body suitable for fixing a free edge of the preliminary lateral wall in locked conditions in order to turn the preliminary lateral wall outwards and downwards so that the material constituting the upper portion of the preliminary lateral wall comes step by step to constitute the external strip, the apparatus performing the steps of manufacturing a preliminary lateral wall of tubular shape and of paper material, forming an internal cavity, and a step, subsequent to the manufacture of the preliminary lateral wall, of predisposing an external strip of paper material, joined to the lateral wall and emerging and parting downwards from the lateral wall so as to form an insulating interspace between the external strip and the lateral wall, the external strip forming a free lower edge such as to leave open said insulating interspace.

59. The apparatus according to claim 58, further comprising a lower guide body configured for cooperating with the upper guide body to form the external strip, said upper and lower guide bodies being movable along an axis of extension of the lateral wall relative to the male and female dies in locked conditions of the preliminary lateral wall and comprising furthermore a shaping element, the lower guide body cooperating with the shaping element to compress an upper portion of the preliminary lateral wall against the shaping element itself and form an enrichment of raw material for the creation of the external strip.
